(19) United States
(12) Patent Application Publication
(10) Pub. No.: US 2013/0196079 A1
(43) Pub. Date: Aug. 1, 2013

(54) RADIATION-CURABLE ANTIMICROBIAL COATING COMPOSITION

(71) Applicants: Reinhold Schwalm, Wachenheim (DE); Rupert Konradi, Ladenburg (DE); Herbert Platsch, Mannheim (DE); Christina Haaf, Hemsbach (DE); Catharina Hippius, Mannheim (DE)

(72) Inventors: Reinhold Schwalm, Wachenheim (DE); Rupert Konradi, Ladenburg (DE); Herbert Platsch, Mannheim (DE); Christina Haaf, Hemsbach (DE); Catharina Hippius, Mannheim (DE)

(21) Appl. No.: 13/747,778

(22) Filed: Jan. 23, 2013

Related U.S. Application Data
(60) Provisional application No. 61/591,292, filed on Jan. 27, 2012.

(51) Int. Cl. C09D 5/14

(52) U.S. Cl. CPC C09D 5/14
USPC 427/551; 522/172

(57) ABSTRACT

The present invention relates to a radiation-curable antimicrobial coating composition, to a process for preparation thereof, and to the use thereof.

The present invention relates to a radiation-curable antimicrobial coating composition, to a process for preparation thereof, and to the use thereof.

WO 2008/131715 discloses silane-functional reaction products of diols with isocyanatopropyltriethoxysilane which lead in coating compositions to easy-clean coatings.

WO 2008/132045 describes compounds which carry at least one quaternary ammonium group and at least one (meth)acrylate group. Compounds of this kind are used in radiation-curable coating compositions and lead to biocidal coatings.

WO 2008/31596 describes coating compositions for producing radiation-curable medical coatings, in which hydrophilic polyfunctional (meth)acrylamides are used. In order to acquire antimicrobial properties, it is necessary to add compounds with antimicrobial activity to these coating compositions.

DE 19921904 discloses compounds for antimicrobial coating compositions that have silyl groups and (meth)acrylate groups.

DE 19700081 discloses radiation-curable, antimicrobial coating compositions comprising silylated (meth)acrylates, cinnamoylethyl (meth)acrylate, other radiation-curable monomers, such as (meth)acrylates, for example, and also ammonium compounds. A disadvantage is that the effect of the antimicrobial coating compositions is relatively weak and derives predominantly only from an antiadhesive effect rather than a biocidal effect.

It was an object of the present invention to provide radiation-curable coating compositions which can be equipped with a rapid and complete or near-complete antimicrobial activity and which at the same time produce coatings having good film properties.

This object has been achieved by an antimicrobial, radiation-curable coating composition comprising
(A) at least one compound having at least one quaternary ammonium group, substituted by four radicals which have in total at least 12 carbon atoms, of which at least one radical, preferably two radicals, each carry a hydroxyl group or each carry an alkoxysilane group,
(B) at least one reactive diluent, selected from the group consisting of hydroxyalkyl (meth)acrylates and N-vinyl lactams,
(C) optionally at least one reactive diluent other than (B),
(D) optionally at least one photoinitiator, and
(E) optionally at least one other coatings additive.

The radiation-curable, antimicrobial coating compositions of the invention exhibit a strong and rapid antimicrobial activity which persists over a relatively long time, and at the same time the coatings obtained with these compositions exhibit good film properties, especially hardness.

The at least one compound (A) is of the kind comprising at least one quaternary ammonium group, substituted by four radicals which have in total at least 12 carbon atoms, and in which at least one of the radicals carries a hydroxyl group or an alkoxysilane group.

In one preferred embodiment, two of the four radicals have at least eight carbon atoms.

The compounds (A) have preferably one to four, more preferably one to three, very preferably one to two, and more particularly just one quaternary ammonium group.

Compounds (A) are differentiated as compounds (A1), which have at least one radical, preferably two radicals, which each carry a hydroxyl group, and compounds (A2), which have at least one radical, preferably two radicals, which each carry an alkoxysilane group.

“Quaternary ammonium groups” in the sense of the present specification are those which are substituted by hydrocarbon radicals and spacers having at least one hydroxyl group and/or alkoxysilane group. The number of carbon atoms in these quaternary ammonium groups is determined as the sum of the carbon atoms in the hydrocarbon radicals and also of the carbon atoms in the spacer, account being taken here only of the carbon atoms between the nitrogen atom of the quaternary ammonium group and the first heteroatom in the chain.

The spacer comprises at least one carbon atom, preferably at least two carbon atoms.

Generally speaking, the spacer is not longer than ten carbon atoms, preferably not longer than six carbon atoms, and very preferably not longer than four carbon atoms.

Where the quaternary ammonium group comprises a ring, for example, then the carbon atoms of the ring are of course included only once in the calculation.

Preferred compounds (A1) are those having two hydroxyl groups. Particularly preferred are bis(2-hydroxyethyl)alkylmethylammonium salts, bis(2-hydroxypropyl)alkylmethylammonium salts, bis(2-hydroxyethyl)alkylbenzylammonium salts and bis(2-hydroxypropyl)alkylbenzyl-ammonium salts, in which the alkyl radical comprises preferably at least 6, more preferably at least 8 and very preferably at least 12 carbon atoms. Preference is furthermore given to those products of such compounds that have been further reacted one to fifty times, preferably two to thirty times, and more preferably four to twenty times with ethylene oxide and/or propylene oxide, preferably only with ethylene oxide.

In one preferred embodiment for compounds (A2), the quaternary ammonium group has the following formula (I)

R¹R²R³N⁺—R⁴—

in which
R¹, R², and R³ each independently of one another are alkyl groups having 1 to 20, preferably one to 15 carbon atoms, aryl groups having 6 to 14, preferably 6 to 10, more preferably 6 carbon atoms, or aralkyl groups having 7 to 20, preferably 7 to 15, more preferably 7 to 10 carbon atoms, it also being possible for two of the radicals R¹ to R³ together to be part of a ring, and
R⁴ is a divalent hydrocarbon radical having 1 to 10, preferably 2 to 6, more preferably 2 to 4 carbon atoms.

Examples of alkyl groups having 1 to 20 carbon atoms are methyl, ethyl, isopropyl, n-propyl, n-butyl, isobutyl, sec-butyl, tert-butyl, n-hexyl, n-heptyl, 2-ethylhexyl, n-octyl, n-decyl, 2-propylheptyl, n-dodecyl, isotridecyl, n-tetradecyl, n-hexadecyl, n-octadecyl, and n-eicosyl.

Examples of aryl groups having 6 to 14 carbon atoms are phenyl, α-napththyl, and β-napththyl.

Examples of aralkyl groups having 7 to 20 carbon atoms are benzyl, phenethyl, 3-phenylpropyl, 4-phenylbutyl, and 6-phenylhexyl.

Examples of divalent hydrocarbon radicals having 1 to 10 carbon atoms are 1,2-ethylene, 1,2-propylene, 1,3-propylene, 1,2-butylene, 1,3-butylene, 1,4-butylene, 1,6-hexylene, 2-methyl-1,3-propylene, 2-ethyl-1,3-propylene, 2,2-dimethyl-1,3-propylene, 1,8-octylene, and 1,10-decylene.

Preferably the radicals R¹ to R³ each independently of one another are alkyl groups.

In one preferred embodiment of the present invention, the groups R¹ to R⁴ in the quaternary ammonium groups of the formula (I) have in total at least 12 carbon atoms, preferably at least 14, more preferably at least 16, and very preferably at least 18 carbon atoms.

In another preferred embodiment at least one, preferably just one, of the radicals R¹ to R³ has at least 10 and preferably at least 12 carbon atoms.

In another preferred embodiment, one of the radicals R¹ to R³ has at least 10 and preferably at least 12 carbon atoms, and the two others each have not more than 4, preferably not more than 2, carbon atoms.

The compounds (A) preferably have an ammonium group density of at least 0.5 mol per 1000 g, more preferably of 0.5 to 3.5, and very preferably of 1.5 to 3 mol per 1000 g.

### Components (A2)

The at least one, one to four for example, preferably one to three, more preferably one to two, and very preferably just one compound (A2) has at least one, one to three for example, preferably one to two, and more preferably just one group that is reactive toward hydroxyl groups, and has at least one, one to four for example, preferably one to three, more preferably one to two, and very preferably just one quaternary ammonium group.

Particularly preferred compounds (A2) are those of the formula (II)

R¹R²R³N⁺—R⁴—Y

in which
R¹ to R⁴ have the definitions stated above and
Y is an alkoxysilane group.

Preferred compounds (A2) are octadecyldimethyl[3-(trisalkyloxysilyl)propyl]ammonium, octadecyldimethyl[2-(trisalkyloxysilyl)ethyl]ammonium, hexadecyldimethyl-[3-(trisalkyloxysilyl)propyl]ammonium, hexadecyldimethyl[2-(trisalkyloxysilyl)ethyl]ammonium, tetradecyldimethyl-[3-(trisalkyloxysilyl)propyl]ammonium, tetradecyldimethyl-[2-(trisalkyloxysilyl)ethyl]ammonium, dodecyldimethyl[3-(trisalkyloxysily 0 propyl]ammonium, dodecyldimethyl-[2-(trisalkyloxysilyl)ethyl]ammonium, decyldimethyl-[3-(trisalkyloxysilyl)propyl]ammonium, and decyldimethyl[2-(trisalkyloxysilyl)ethyl]ammonium, with possible counterions for the ammonium groups being in each case chloride, bromide, iodide, tosylate, sulfate, hydrogensulfate, phosphate, hydrogenphosphate, dihydrogenphosphate, sulfonate, and hydrogensulfonate.

It is generally sufficient here if a silyl group is substituted by at least one alkoxy radical, one to three for example, preferably two or three, and very preferably by three.

The groups in question are preferably tris(alkyloxy)silyl groups or alkylbis(alkyloxy)silyl groups, more preferably tris(C₁-C₄-alkyloxy)silylgroups or C₁-C₄-alkylbis(C₁-C4-alkyloxy)silylgroups.

With particular preference the groups in question are diethoxymethylsilyl, dimethoxymethylsilyl, methoxydimethylsilyl, ethoxydimethylsilyl, phenoxydimethylsilyl, triethoxysilyl or trimethoxysilyl groups.

Preferred compounds (A2) are those of the formula (IV)

R¹R²R³N⁺—R⁴—Si(OR⁷)₃

in which
R¹ to R⁴ have the above definitions and
R⁷ is C₁-C₆-alkyl, preferably C₁-C₄-alkyl, more preferably methyl, ethyl, n-propyl, tert-butyl, and n-butyl, very preferably methyl, ethyl, and n-butyl, and more particularly methyl.

Preferred compounds (A2) are 3-ammoniopropylsiloxanes and 2-ammonioethylsiloxanes, the ammonio groups being defined in each case as above.

### Components (B) and (C)

The mixture of the compounds (A) according to the invention comprises at least one reactive diluent (B) and also, optionally, at least one further reactive diluent (C), which is different from (B).

Compounds (B) and (C) are compounds of the kind typically used as reactive diluents. These include, for example, the reactive diluents as described in P.K.T. Oldring (editor), Chemistry & Technology of UV & EB Formulations for Coatings, Inks & Paints, Vol. II, Chapter III: Reactive Diluents for UV & EB Curable Formulations, Wiley and SITA Technology, London 1997.

Examples of reactive diluents include esters of (meth)acrylic acid with alcohols which have 1 to 20 C atoms, e.g., methyl (meth)acrylate, ethyl (meth)acrylate, butyl (meth)acrylate, 2-ethylhexyl (meth)acrylate, 2-hydroxyethyl (meth)acrylate, 2-hydroxypropyl (meth)acrylate, 4-hydroxybutyl acrylate, dihydrodicyclopentadienyl acrylate.

Compounds having at least two free-radically polymerizable C═C double bonds: these include, in particular, the diesters and polyesters of the aforementioned α,β-ethylenically unsaturated monocarboxylic and/or dicarboxylic acids with diols or polyols. Particularly preferred are hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, pentaerythritol diacrylate, dipentaerythritol tetraacrylate, dipentaerythritol triacrylate, pentaerythritol tetraacrylate, etc. Also preferred are the esters of alkoxylated polyols with α,β-ethylenically unsaturated monocarboxylic and/or dicarboxylic acids, such as, for example, the polyacrylates or polymethacrylates of alkoxylated trimethylolpropane, glycerol or pentaerythritol. Additionally suitable are the esters of alicyclic diols, such as cyclohexanediol di(meth)acrylate and bis(hydroxymethylethyl)cyclohexane di(meth)acrylate.

Further suitable reactive diluents are trimethylolpropane monoformal acrylate, glycerol formal acrylate, 4-tetrahydropyranyl acrylate, 2-tetrahydropyranyl methacrylate, and tetrahydrofurfuryl acrylate.

Further suitable reactive diluents are, for example, polyether (meth)acrylates.

Polyether (meth)acrylates are preferably (meth)acrylates of singly to vigintuply and more preferably triply to decuply ethoxylated, propoxylated or mixedly ethoxylated and propoxylated, and more particularly exclusively ethoxylated, neopentylglycol, trimethylolpropane, trimethylolethane or pentaerythritol.

It is possible, furthermore, to use singly to vigintuply and more preferably triply to decuply ethoxylated, propoxylated or mixedly ethoxylated and propoxylated, and more particularly exclusively ethoxylated, glycerol.

Preferred polyfunctional, polymerizable compounds are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythritol tetraacrylate, polyesterpolyol acrylates, polyetherol acrylates, and triacrylate of singly to vigintuply alkoxylated, more preferably ethoxylated, trimethylolpropane.

Polyether (meth)acrylates may also be (meth)acrylates of polyTHF having a molar weight between 162 and 2000, poly-1,3-propanediol having a molar weight between 134 and 2000 or polyethylene glycol having a molar weight between 238 and 2000.

The compounds (B) are selected from the group consisting of hydroxyalkyl (meth)acrylates and N-vinyl lactams, and preferably are hydroxyalkyl (meth)acrylates

Hydroxyalkyl (meth)acrylates as compounds (B) are, for example, compounds having at least one, preferably just one hydroxyl group and at least one, 1 to 5 for example, preferably 1 to 4, more preferably 1 to 3, very preferably 1 or 2, and more particularly just one (meth)acrylate group, preferably w-hydroxyalkyl (meth)acrylates or (ω-1)-hydroxyalkyl (meth)acrylates, preferably w-hydroxyalkyl (meth)acrylates.

Particularly preferred hydroxyalkyl (meth)acrylates (B) are those of the formula

H₂C═C(R⁹)COO—R⁸—OH,

in which
R⁹ is hydrogen or methyl, preferably hydrogen, and
R⁸ is a divalent hydrocarbon radical having 2 to 10, preferably 2 to 6, more preferably 2 to 4 carbon atoms.

Preferred radicals R⁸ are, for example, linear or branched alkylene, e.g., 1,2-ethylene, 1,2- or 1,3-propylene, 1,2-, 1,3- or 1,4-butylene, 1,1-dimethyl-1,2-ethylene or 1,2-dimethyl-1,2-ethylene, 1,5-pentylene, 1,6-hexylene, 1,8-octylene, 1,10-decylene, or 1,12-dodecylene. Preference is given to 1,2-ethylene, 1,2- or 1,3-propylene, 1,4-butylene, and 1,6-hexylene, particular preference to 1,2-ethylene, 1,2- or 1,3-propylene, very particular preference to 1,2-ethylene and 1,2-propylene, and, more particularly, 1,2-ethylene.

The compound (B) is preferably 2-hydroxyethyl acrylate, 2-hydroxypropyl acrylate, 3-hydroxypropyl acrylate, 2-hydroxypropyl methacrylate, 2-hydroxyethyl methacrylate, 4-hydroxybutyl acrylate, pentaerythritol triacrylate or trimethylolpropane dimethacrylate, more preferably 2-hydroxyethyl acrylate, 2-hydroxypropyl acrylate, 2-hydroxypropyl methacrylate, 4-hydroxybutyl acrylate or 2-hydroxyethyl methacrylate, and very preferably 4-hydroxybutyl acrylate, 2-hydroxyethyl acrylate, 2-hydroxypropyl acrylate or 2-hydroxyethyl methacrylate. More particularly the compound (B) is selected from the group consisting of 4-hydroxybutyl acrylate and 2-hydroxyethyl methacrylate.

N-Vinyl lactams as compounds (B) are preferably N-vinylated lactams having five- to twelve-membered ring systems, preferably five- to ten-membered and more preferably five- to seven-membered ring systems.

Preferred N-vinyl lactams are those of the formula

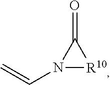

in which
R¹⁰ is a divalent hydrocarbon radical having 2 to 10, preferably 2 to 6, more preferably 3 to 5 carbon atoms.

Preferred radicals R¹¹ are, for example, linear or branched alkylene, e.g. 1,2-ethylene, 1,2- or 1,3-propylene, 1,2-, 1,3- or 1,4-butylene, 1,1-dimethyl-1,2-ethylene or 1,2-dimethyl-1,2-ethylene, 1,5-pentylene, 1,6-hexylene, 1,8-octylene or 1,10-decylene. Preference is given to 1,3-propylene, 1,4-butylene, 1,5-pentylene, 1,5-hexylene, and 1,6-hexylene, particular preference to 1,3-propylene, 1,4-butylene, and 1,5-pentylene, very particular preference to 1,3-propylene and 1,5-pentylene.

Preferred N-vinyl lactams as compounds (B) are N-vinylpyrrolidone or N-vinylcaprolactam.

Compound (B) may be a single compound or a mixture of two or more, up to four for example, preferably up to three compounds, more preferably one or two compounds, and very preferably just one compound.

Optionally there may be at least one reactive diluent (C) present, which is different from the reactive diluent (B).

Particularly preferred compounds (C) are polyfunctional (meth)acrylates, in other words having a functionality of at least 2, 2 to 10 for example, preferably 2 to 6, more preferably 2 to 5, and very preferably 2 to 4.

Compounds (C) of the kind used typically as reactive diluents are known per se to the skilled person. They include, for example, the reactive diluents as described in P.K.T. Oldring (editor), Chemistry & Technology of UV & EB Formulations for Coatings, Inks & Paints, Vol. II, Chapter III: Reactive Diluents for UV & EB Curable Formulations, Wiley and SITA Technology, London 1997.

Compounds having at least two free-radically polymerizable C═C double bonds: these include, in particular, the diesters and polyesters of (meth)acrylic acid with diols or polyols. Particularly preferred are 1,4-butanediol di(meth)acrylate, 1,6-hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, diethylene glycol di(meth)acrylate, triethylene glycol di(meth)acrylate, dipropylene glycol di(meth)acrylate, tripropylene glycol di(meth)acrylate, pentaerythritol diacrylate, dipentaerythritol tetraacrylate, dipentaerythritol triacrylate, pentaerythritol tetraacrylate, etc.

Also preferred are the esters of alkoxylated polyols with (meth)acrylic acid, such as the polyacrylates or polymethacrylates of, on average per OH group, singly to decuply, preferably singly to pentuply, more preferably singly to triply, and very preferably singly to doubly alkoxylated, for example ethoxylated and/or propoxylated, preferably ethoxylated or propoxylated, and more preferably exclusively ethoxylated, trimethylolpropane, glycerol or pentaerythritol.

Additionally suitable are the esters of alicyclic diols, such as cyclohexanediol di(meth)acrylate and bis(hydroxymethylethyl)cyclohexane di(meth)acrylate.

Further suitable reactive diluents are for example urethane (meth)acrylates, epoxy (meth)acrylates, polyether (meth)acrylates, polyester (meth)acrylates or polycarbonate (meth)acrylates.

Urethane (Meth)Acrylates

Urethane (meth)acrylates are obtainable for example by reacting polyisocyanates with hydroxyalkyl (meth)acrylates or hydroxyalkyl vinyl ethers and, optionally, chain extenders such as diols, polyols, diamines, polyamines, or dithiols or polythiols.

Urethane (meth)acrylates of this kind comprise as synthesis components substantially:
(1) at least one organic aliphatic, aromatic or cycloaliphatic di- or polyisocyanate,
(2) at least one compound having at least one isocyanate-reactive group and at least one free-radically polymerizable unsaturated group, and
(3) optionally, at least one compound having at least two isocyanate-reactive groups.

The urethane (meth)acrylates preferably have a number-average molar weight Mₙ of 500 to 20 000, in particular of 500 to 10 000 and more preferably 600 to 3000 g/mol (determined by gel permeation chromatography using tetrahydrofuran and polystyrene as standard).

The urethane (meth)acrylates preferably have a (meth)acrylic group content of 1 to 5, more preferably of 2 to 4, mol per 1000 g of urethane (meth)acrylate.

Particularly preferred urethane (meth)acrylates have an average functionality of 1.5 to 4.5.

Epoxy (Meth)Acrylates

Epoxy (meth)acrylates are preferably obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, isobutylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxy-propoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Preference is given to bisphenol A diglycidyl ether, bisphenol F diglycidyl ether, bisphenol B diglycidyl ether, and bisphenol S diglycidyl ether, and bisphenol A diglycidyl ether is particularly preferred.

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

Preference is given to 1,4-butanediol diglycidyl ether, 1,6-hexanediol diglycidyl ether, trimethylolpropane triglycidyl ether, pentaerythritol tetraglycidyl ether, and 2,2-bis[4-(2,3-epoxy-propoxy)cyclohexyl]propane.

The abovementioned aromatic glycidyl ethers are particularly preferred.

The epoxy (meth)acrylates and epoxy vinyl ethers preferably have a number-average molar weight Mₙ of 200 to 20 000, more preferably of 200 to 10 000 g/mol, and very preferably of 250 to 3000 g/mol; the amount of (meth)acrylic or vinyl ether groups is preferably 1 to 5, more preferably 2 to 4, per 1000 g of epoxy (meth)acrylate or vinyl ether epoxide (determined by gel permeation chromatography using polystyrene as standard and tetrahydrofuran as eluent).

Preferred epoxy (meth)acrylates have an OH number of 40 to 400 mg KOH/g.

Preferred epoxy (meth)acrylates have an average OH functionality of 1.5 to 4.5.

Particularly preferred epoxy (meth)acrylates are those such as are obtained from processes in accordance with EP-A-54 105, DE-A 33 16 593, EP-A 680 985, and E-A-279 303, in which in a first stage a (meth)acrylic ester is prepared from (meth)acrylic acid and hydroxy compounds and in a second stage excess (meth)acrylic acid is reacted with epoxides.

### Polyester (Meth)Acrylates

Suitable polyester (meth)acrylates are at least partly or, preferably, completely (meth)acrylated reaction products of polyesterols of the kind listed above under compounds a4).

### Carbonate (Meth)Acrylates

Carbonate (meth)acrylates comprise on average preferably 1 to 5, especially 2 to 4, more preferably 2 to 3 (meth)acrylic groups, and very preferably 2 (meth)acrylic groups.

The number-average molecular weight Mₙ of the carbonate (meth)acrylates is preferably less than 3000 g/mol, more preferably less than 1500 g/mol, very preferably less than 800 g/mol (determined by gel permeation chromatography using polystyrene as standard, tetrahydrofuran as solvent).

The carbonate (meth)acrylates are obtainable in a simple manner by transesterifying carbonic esters with polyhydric, preferably dihydric, alcohols (diols, hexanediol for example) and subsequently esterifying the free OH groups with (meth)acrylic acid, or else by transesterification with (meth)acrylic esters, as described for example in EP-A 92 269. They are also obtainable by reacting phosgene, urea derivatives with polyhydric, e.g., dihydric, alcohols.

Also conceivable are (meth)acrylates or vinyl ethers of polycarbonate polyols, such as the reaction product of one of the aforementioned diols or polyols and a carbonic ester and also a hydroxyl-containing (meth)acrylate or vinyl ether.

Examples of suitable carbonic esters include ethylene carbonate, 1,2- or 1,3-propylene carbonate, dimethyl carbonate, diethyl carbonate or dibutyl carbonate.

Examples of suitable hydroxyl-containing (meth)acrylates are 2-hydroxyethyl (meth)acrylate, 2- or 3-hydroxypropyl (meth)acrylate, 1,4-butanediol mono(meth)acrylate, neopentylglycol mono(meth)acrylate, glyceryl mono- and di(meth)acrylate, trimethylolpropane mono- and di(meth)acrylate, and pentaerythrityl mono-, di-, and tri(meth)acrylate.

Suitable hydroxyl-containing vinyl ethers are, for example, 2-hydroxyethyl vinyl ether and 4-hydroxybutyl vinyl ether.

Particularly preferred carbonate (meth)acrylates are those of the formula:

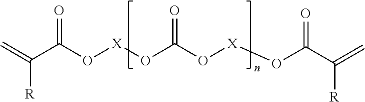

in which R is H or CH₃, X is a C₂-C₁₈ alkylene group, and n is an integer from 1 to 5, preferably 1 to 3.

R is preferably H and X is preferably C₂ to C₁₀ alkylene, examples being 1,2-ethylene, 1,2-propylene, 1,3-propylene, 1,4-butylene, and 1,6-hexylene, more preferably C₄ to C₈ alkylene. With very particular preference X is C₆ alkylene.

The carbonate (meth)acrylates are preferably aliphatic carbonate (meth)acrylates.

They further include customary polycarbonates known to the skilled person and having terminal hydroxyl groups, which are obtainable, for example, by reacting the aforementioned diols with phosgene or carbonic diesters.

### Polyether (Meth)Acrylates

Polyether (meth)acrylates are preferably (meth)acrylates of singly to vigintuply and more preferably triply to decuply ethoxylated, propoxylated or mixedly ethoxylated and propoxylated, and more particularly exclusively ethoxylated, neopentylglycol, trimethylolpropane, trimethylolethane or pentaerythritol.

In addition it is possible to use singly to vigintuply and more preferably triply to decuply ethoxylated, propoxylated or mixedly ethoxylated and propoxylated, and more particularly exclusively ethoxylated, glycerol.

Preferred polyfunctional, polymerizable compounds are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythrityl tetraacrylate, polyesterpolyol acrylates, polyetherol acrylates, and triacrylate of singly to vigintuply alkoxylated, more preferably ethoxylated, trimethylolpropane.

Polyether (meth)acrylates may further be (meth)acrylates of polyTHF having a molar weight between 162 and 2000, poly-1,3-propanediol having a molar weight between 134 and 2000, or polyethylene glycol having a molar weight between 238 and 2000.

In one preferred embodiment of the present invention there is no compound (C) present.

Where the coating compositions of the invention are cured not with electron beams but instead by means of UV radiation, the preparations of the invention preferably comprise at least one photoinitiator (D) which is able to initiate the polymerization of ethylenically unsaturated double bonds.

Photoinitiators (D) may be, for example, photoinitiators known to the skilled person, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Suitability is possessed by those photoinitiators as described in WO 2006/005491 A1, page 21 line 18 to page 22 line 2 (corresponding to US 2006/0009589 A1, paragraph [0150]), which is hereby considered part of the present disclosure through reference.

Also suitable are nonyellowing or low-yellowing photoinitiators of the phenylglyoxalic ester type, as described in DE-A 198 26 712, DE-A 199 13 353 or WO 98/33761.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentylphosphine oxide and 1-hydroxycyclohexyl phenyl ketone, 2,4,6-trimethylbenzoyldiphenylphosphine oxide and 2-hydroxy-2-methyl-1-phenylpropan-1-one, 2,4,6-trimethylbenzophenone and 4-methylbenzophenone or 2,4,6-trimethylbenzophenone, and 4-methylbenzophenone and 2,4,6-trimethylbenzoyldiphenylphosphine oxide.

Preference among these photoinitiators is given to 2,4,6-trimethylbenzoyldiphenylphosphine oxide, ethyl 2,4,6-trimethylbenzoylphenylphosphinate, bis(2,4,6-trimethyl-benzoyl)phenylphosphine oxide, benzophenone, 1-hydroxycyclohexyl phenyl ketone, 1-benzoylcyclohexan-1-ol, 2-hydroxy-2,2-dimethylacetophenone, 2,2-dimethoxy-2-phenylacetophenone, and mixtures thereof.

The coating compositions of the invention comprise the photoinitiators (D) preferably in an amount of 0.05% to 10%, more preferably 0.1% to 8%, in particular 0.2% to 5%, by weight based on the total amount of the radiation-curable compounds (A) and (B) and also optionally (C).

The dispersions of the invention may comprise further customary coatings additives (E), such as flow control agents, defoamers, UV absorbers, sterically hindered amines (HALS), plasticizers, antisettling agents, dyes, pigments, antioxidants, activators (accelerants), antistatic agents, flame retardants, thickeners, thixotropic agents, surface-active agents, viscosity modifiers, plastifying agents or chelating agents and/or fillers.

The coating compositions of the invention may comprise 0% to 10% by weight, based on the sum of the compounds (A) and (B) and also optionally (C), of at least one compound (E).

Suitable stabilizers comprise typical UV absorbers such as oxanilides, triazines, preferably hydroxyphenyltriazine, and benzotriazole (the latter obtainable as Tinuvin® grades from Ciba Spezialitätenchemie) and benzophenones.

These stabilizers can be used alone or together with, based on the sum of compounds (A) and (B) and also optionally (C), additionally 0% to 5% by weight of suitable free-radical scavengers, examples being sterically hindered amines such as 2,2,6,6-tetramethylpiperidine, 2,6-di-tert-butylpiperidine or derivatives thereof, e.g. bis(2,2,6,6-tetramethyl-4-piperidyl)sebacate or preferably bis(1,2,2,6,6-pentamethyl-4-piperidyl)sebacate.

Additionally it is possible for one or more thermally activatable initiators to be added, examples being potassium peroxodisulfate, dibenzoyl peroxide, cyclohexanone peroxide, di-tert-butyl peroxide, azobisisobutyronitrile, cyclohexylsulfonyl acetyl peroxide, diisopropyl percarbonate, tert-butyl peroctoate or benzpinacol, and also, for example, those thermally activatable initiators which have a half-life at 80° C. of more than 100 hours, such as di-tert-butyl peroxide, cumene hydroperoxide, dicumyl peroxide, tert-butyl perbenzoate, silylated pinacols, which are available commercially, for example, under the trade name ADDID 600 from Wacker, or amine N-oxides containing hydroxyl groups, such as 2,2,6,6-tetramethylpiperidine-N-oxyl, 4-hydroxy-2,2,6,6-tetramethylpiperidine-N-oxyl, etc.

Further examples of suitable initiators are described in “Polymer Handbook”, 2nd ed., Wiley & Sons, New York.

Thickeners contemplated are, besides free-radically (co)polymerized (co)polymers, customary organic and inorganic thickeners such as hydroxymethylcellulose or bentonite.

Examples of chelating agents which can be used include ethylenediamineacetic acid and salts thereof, and also β-diketones.

Suitable fillers comprise silicates, e.g., silicates obtainable by hydrolysis of silicon tetrachloride, such as Aerosil R from Degussa, siliceous earth, talc, aluminum silicates, magnesium silicates, calcium carbonates, etc. Suitable stabilizers comprise typical UV absorbers such as oxanilides, triazines, and benzotriazole (the latter obtainable as Tinuvin R grades from Ciba Spezialitätnchemie), and benzophenones. They can be used alone or together with suitable free-radical scavengers, examples being sterically hindered amines such as 2,2,6,6-tetramethyl-piperidine, 2,6-di-tert-butylpiperidine or derivatives thereof, e.g., bis(2,2,6,6-tetramethyl-4-piperidyl)sebacate. Stabilizers are used usually in amounts of 0.1% to 5.0% by weight, based on the “solid” components comprised in the preparation.

The antimicrobial, radiation-curable coating compositions of the invention generally have the following composition in % by weight:

(A) 2 to 90, preferably 4 to 80, more preferably 8 to 70,
(B) 10 to 80, preferably 20 to 70, more preferably 30 to 60,
(C) 0 to 84, preferably 0 to 75, more preferably 0 to 60, and very preferably 0,
(D) 0 to 10, preferably 0.05 to 10, more preferably 0.1 to 8, more particularly 0.2 to 5,
(E) 0 to 20, preferably 0 to 10, more preferably 0 to 1,
with the proviso that the total is always 100% by weight.

One particularly preferred radiation-curable coating composition comprises 2% to 90%, preferably 4% to 80%, more preferably 8% to 70% by weight of octadecyldimethyl(trimethoxysilyl)propylammonium chloride and 98% to 10%, preferably 94% to 20%, more preferably 92% to 30% by weight of 4-hydroxybutyl acrylate or 2-hydroxyethyl methacrylate,

with the proviso that the total is 100% by weight.

Generally speaking it is sufficient, for the coating compositions of the invention to have antimicrobial activity, if in a coating composition there are at least 4% by weight of component (A) and at least 10% by weight of component (B), based on the total amount of components (A) to (E). This antimicrobial activity is evaluated using the test reported in the examples, with incubation over 2 hours; the coating compositions of the invention preferably already exhibit antimicrobial activity on incubation over 1.5 hours, more preferably over 1 hour, very preferably over 45 minutes, more particularly over 30 minutes, and even over 10 minutes.

These particularly preferred radiation-curable coating compositions are suitable preferably as masterbatches for antimicrobial coating compositions.

The coating compositions of the invention are particularly suitable for coating substrates such as wood, paper, textile, leather, nonwoven, plastics surfaces, glass, ceramic, mineral building materials, such as cement moldings and fiber-cement slabs, and, in particular, metals or coated metals. Preference is given to the coating of steel, especially medical steel, and plastics, more particularly acrylonitrile-butadiene-styrene (ABS) and polycarbonate (PC) plastics.

The antimicrobial, radiation-curable coating compositions of the invention are suitable with particular advantage for the coating of medical devices and articles, examples being laboratory tables, operating tables, work surfaces and device surfaces.

The substrates are coated in accordance with customary methods that are known to the skilled person, involving the application of at least one coating composition of the invention to the substrate that is to be coated, in the desired thickness and the removal from the coating composition of any volatile constituents present. This process can be repeated one or more times if desired. Application to the substrate may take place in a known way, e.g., by spraying, troweling, knifecoating, brushing, rolling, roller-coating or pouring. The coating thickness is generally situated within a range from about 3 to 1000 g/m² and preferably 10 to 200 g/m2.

To remove the volatile constituents present in the coating composition, the coating can optionally be dried following application to the substrate, drying taking place for example in a tunnel oven or by flashing off. Drying can also take place by means of NIR radiation, NIR radiation here meaning electromagnetic radiation in the wavelength range from 760 nm to 2.5 μm, preferably from 900 to 1500 nm.

Optionally, if two or more films of the coating material are applied one on top of another, a radiation cure may take place after each coating operation.

Radiation curing is accomplished by exposure to high-energy radiation, i.e., UV radiation or daylight, preferably light with a wavelength of 250 to 600 nm, or by irradiation with high-energy electrons (electron beams; 150 to 300 keV). Examples of radiation sources used include high-pressure mercury vapor lamps, lasers, pulsed lamps (flash light), halogen lamps or excimer emitters. The radiation dose normally sufficient for crosslinking in the case of UV curing is situated within the range from 80 to 3000 mJ/cm².

Irradiation may also optionally be carried out in the absence of oxygen, e.g., under an inert gas atmosphere. Suitable inert gases include, preferably, nitrogen, noble gases, carbon dioxide or combustion gases. Irradiation may also take place with the coating composition being covered by transparent media. Transparent media are, for example, polymeric films, glass or liquids, e.g., water. Particular preference is given to irradiation in the manner as is described in DE-A1 199 57 900.

In one preferred process, curing takes place continuously, by passing the substrate treated with the preparation of the invention at constant speed past a radiation source. For this it is necessary for the cure rate of the preparation of the invention to be sufficiently high.

This varied course of curing over time can be exploited in particular when the coating of the article is followed by a further processing step in which the film surface comes into direct contact with another article or is worked on mechanically.

The invention is illustrated in more detail by means of the following, nonlimiting examples.

### EXAMPLES

Unless indicated otherwise, parts and percentages indicated are by weight. Determination of antimicrobial activity by fluorescence microscopy

### 1. Bacterial Culture:

50 ml of DSM 92 medium (=TSBY Medium, Deutsche Sammlung von Mikroorganismen and Zellkulturen GmbH) in an Erlenmeyer flask with chicane are inoculated with a single colony of Staphylococcus aureus ATCC 6538P and incubated at 190 rpm and 37° C. for 16 hours. The resulting preliminary culture has a cell density of approximately 10⁸ CFU/ml, corresponding to an optical density of OD=7.0-8.0. Using this preliminary culture, 15 ml of main culture in 5% DSM 92 medium with an optical density of OD=1.0 are prepared.

Analogous Cultures are Prepared for Testing with
E. coli ATCC=8739: preliminary culture 100% DSM 1 medium (nutrient medium without agar), main culture 5% DSM 1 medium
S. faecalis ATCC=11700 preliminary culture 100% DMS 53 medium (Corynebacterium medium without agar), main culture 5% DSM 53 medium
P. aeruginosa ATCC=15442 (incubation at 30° C.): preliminary culture 100% DSM 546 medium (LC medium), main culture 10% DSM 546 medium

### 2. Fluorescence Staining:

500 μl of the main bacterial culture are stained in accordance with the manufacturer recommendation using 1.5 μl of Syto 9 fluorescent dye and 1.5 μl of propidium iodide fluorescent dye (Film Tracer™ LIVE/DEAD® Biofilm Viability Kit, from Invitrogen). 10 μl of this bacterial suspension are applied to the surface under investigation, and covered with a cover slip. A homogeneous film of liquid is formed, with a thickness of about 30 μm. The test substrates are incubated in the dark at 37° C. for up to 2 hours. After this time, >95% living bacterial cells are found on untreated reference substrates (including pure glass).

### 3. Microscopy:

The test substrates are examined under a Leica DM16000 B microscope with the cover slip facing the lens. Each test substrate is advanced automatically to 15 pre-defined positions, and images are recorded in the three channels of phase contrast (P), red (R) and green (G). The absorbance and emission wavelengths in the fluorescence channels are adapted to the dyes used. Bacteria with an intact cell membrane (living) are detected in the green channel, bacteria with a defective cell membrane (dead) are detected in the red channel. The total of all the bacteria is detected in the phase contrast channel. For each of the 15 positions, the number of bacteria in all 3 channels is counted. The percentage of dead bacteria is calculated either from the numbers in R/(R+G) or, if background fluorescence is observed in the green channel, from R/P. The percentage of dead bacteria is averaged over the 15 positions and reported as the result.

### Example 1

50 parts of octadecyldimethyl(trimethoxysilyl)propylammonium chloride and 50 parts of butanediol monoacrylate were admixed with 2 parts of Irgacure® 500, applied to a slide in a dry film thickness of approximately 25 μm, and cured under a nitrogen atmosphere in an IST exposure unit at about 1400 mJ/cm². The slides were subsequently cured thermally at 100° C. for 30 minutes.

### Example 2

25 parts of octadecyldimethyl(trimethoxysilyl)propylammonium chloride, 25 parts of butanediol monoacrylate, and 50 parts of pentaerythritol triacrylate were admixed with 2 parts of Irgacure® 500, applied to a slide in a dry film thickness of approximately 25 μm, and cured under a nitrogen atmosphere in an IST exposure unit at about 1400 mJ/cm². The slides were subsequently cured thermally at 100° C. for 120 minutes.

| | | % death rate after | % death rate after |
|---|---|---|---|
| | Parts of | 2 hours (fluorescence | 10 minutes |
| Example | O-Quat | microscopy) | (fluorescence microscopy) |
| 1 | 50 | 100 | 100 |
| 2 | 25 | 100 | 100 |

Examples 1 and 2 show coating materials having not only an extremely strong but also an extremely rapid antimicrobial action.

### Example 3

### Determination of Film Hardness (Pendulum Damping)

The pendulum damping was determined in accordance with DIN 53157. For this purpose, the radiation-curable compositions were applied with a wet film thickness of 400 μm to glass. The wet films were first flashed at room temperature for 15 minutes and then dried at 100° C. for 20 minutes. The films obtained in this way were cured at 100° C. in an IST coating unit (type M 40 2×1-R-IR-SLC-So inert) with 2 UV lamps (high-pressure mercury lamps type M 400 U2H and type M 400 U2HC) and with a conveyor-belt speed of 10 m/min under a nitrogen atmosphere (O₂ content not more than 500 ppm). The radiation dose was about 1400 mJ/cm². In embodiment a), curing took place only by radiant energy, as described above. In embodiment b), exposure to UV light took place first, as described above, with subsequent thermal curing to completion.

Film from Example 2: 120 minutes at 100° C. pendulum hardness 90 sec

The antimicrobial properties show no significant change.

This shows that the mechanical properties of the films (hardness) can be enhanced by subsequent thermal treatment without significant deterioration in the antimicrobial activity.

### Example 4

A mixture was prepared from 7 parts of octadecyldimethyl(trimethoxysilyl)propylammonium chloride and 7 parts of butanediol monoacrylate with 68 parts of a urethane acrylate, prepared by reacting a trifunctional isocyanurate based on hexamethylene 1,6-diisocyanate (Basonat® HI100, BASF SE) with 2 mol of hydroxyethyl acrylate and 1 mol of aminopropyltriethoxysilane (based on NCO groups), and with a further 18 parts of butanediol monoacrylate, and 2 parts of Irgacure® 500 were added to this mixture, the resulting composition being applied to slides in a dry film thickness of approximately 25 μm and cured under a nitrogen atmosphere in an IST exposure unit at about 1400 mJ/cm². The slides were subsequently cured thermally at 100° C. for 30 minutes.

### Comparative Example 1 to Example 4

A mixture was prepared from 8 parts of octadecyldimethyl(trimethoxysilyl)propylammonium chloride and 8 parts of butanediol monoacrylate with 64 parts of a urethane acrylate, prepared by reacting a trifunctional isocyanurate based on hexamethylene 1,6-diisocyanate (Basonat®HI100, BASF SE) with 2 mol of hydroxyethyl acrylate and 1 mol of aminopropyltriethoxysilane (based on NCO groups), and with 18 parts of methacrylic acid, and 2 parts of Irgacure® 500 were added to this mixture, the resulting composition being applied to slides in a dry film thickness of approximately 25 μm and cured under a nitrogen atmosphere in an IST exposure unit at about 1400 mJ/cm². The slides were subsequently cured thermally at 100° C. for 30 minutes.

| | Parts of | % death rate after 2 hours |
|---|---|---|
| Example | ammonium salt | (fluorescence microscopy) |
| 4 | 8 | 100 |
| Comp. Ex. 1 | 8 | 0 |

Comparative example 4 shows that with methacrylic acid instead of the reactive diluent (B) there is no inventive effect.

1. An antimicrobial, radiation-curable coating composition comprising
(A) at least one compound having at least one quaternary ammonium group, substituted by four radicals which have in total at least 12 carbon atoms,
(B) at least one reactive diluent, selected from the group consisting of hydroxyalkyl (meth)acrylates and N-vinyl lactams,
(C) optionally at least one reactive diluent other than (B),
(D) optionally at least one photoinitiator, and
(E) optionally at least one other coatings additive.

2. The coating composition according to claim 1, wherein the quaternary ammonium group has the formula (I)
R¹R²R³N⁺—R⁴—
in which
R¹, R², and R³ each independently of one another are alkyl groups having 1 to 20 carbon atoms, aryl groups having 6 to 14 carbon atoms or aralkyl groups having 7 to 20 carbon atoms, it also being possible for two of the radicals R¹ to R³ together to be part of a ring, and
R⁴ is a divalent hydrocarbon radical having 1 to 10 carbon atoms.

3. The coating composition according to claim 2, wherein at least one of the radicals R¹ to R³ has at least 10 carbon atoms.

4. The coating composition according to claim 1, wherein the ammonium group carries four hydrocarbon radicals as substituents on the ammonium group.

5. The coating composition according to any of the preceding claims, wherein compound (A) has an ammonium group density of at least 0.07 mol per 1000 g.

6. The coating composition according to any of the preceding claims, wherein compound (B) is selected from the group consisting of 2-hydroxyethyl acrylate, 2-hydroxypropyl acrylate, 2-hydroxyethyl methacrylate, 4-hydroxybutyl acrylate, pentaerythritol triacrylate, trimethyloipropane dimethacrylate, N-vinylpyrrolidone, and N-vinylcaprolactone.

7. The coating composition according to any of the preceding claims, which comprises
at least 4% by weight of component (A) and
at least 10% by weight of component (B),
relative to the total amount of components (A) to (E).

8. The coating composition according to any of the preceding claims, having the following composition in % by weight:
(A) 2 to 90
(B) 10 to 80
(C) 0 to 84
(D) 0 to 10
(E) 0 to 20
with the proviso that the total is always 100% by weight.

9. The use of coating composition according to any of the preceding claims for coating wood, paper, textile, leather, nonwoven, plastics surfaces, glass, ceramic, mineral building materials, metals or coated metals.

10. The use of coating composition according to any of claims 1 to 8 for coating medical devices and articles.

11. A method for the antimicrobial treatment of a substrate, wherein a coating composition according to any of claims 1 to 8 is applied to the substrate, is optionally dried, and is subsequently cured with high-energy radiation.

12. A radiation-curable coating composition comprising
2% to 90% by weight, preferably 4% to 80% by weight, more preferably 8% to 70% by weight, of octadecyldimethyl(trimethoxysilyl)propylammonium chloride and
98% to 10% by weight, preferably 94% to 20% by weight, more preferably 92% to 30% by weight, of 4-hydroxybutyl acrylate or 2-hydroxyethyl methacrylate,
with the proviso that the total is 100% by weight.

13. The use of radiation-curable coating composition according to claim 12 as masterbatch for antimicrobial coating compositions.
